(19) United States
(12) Patent Application Publication
(10) Pub. No.: US 2026/0040264 A1
(43) Pub. Date: Feb. 5, 2026

(54) POSITIONING PROTOCOL ENHANCEMENTS FOR SIDELINK POSITIONING

(71) Applicant: Apple Inc., Cupertino, CA (US)

(72) Inventors: Alexander Sirotkin, Hod Hasharon (IL); Fangli Xu, Beijing (CN); Haijing Hu, Los Gatos, CA (US); Naveen Kumar R. PALLE VENKATA, San Diego, CA (US); Pavan Nuggehalli, San Carlos, CA (US); Peng Cheng, Beijing (CN); Ralf Rossbach, Munich (DE); Sethuraman Gurumoorthy, San Ramon, CA (US); Yuqin Chen, Beijing (CN); Zhibin Wu, Los Altos, CA (US)

(21) Appl. No.: 19/099,832

(22) PCT Filed: Jul. 27, 2023
(86) PCT No.: PCT/US2023/028844

§ 371 Date: Jan. 30, 2025

Related U.S. Application Data
(60) Provisional application No. 63/395,526, filed on Aug. 5, 2022.

(51) Int. Cl. H04W 64/00; H04W 92/18

(52) U.S. Cl. CPC H04W 64/00; H04W 92/18

(57) ABSTRACT

This disclosure relates to techniques for positioning protocol enhancements for sidelink positioning. In an example, a method to be performed by a first user equipment (UE) includes receiving a positioning message over a sidelink interface between the first UE and a second UE, generating, by the first UE, a response to the positioning message, and transmitting the response to the second UE over the sidelink interface.

### CROSS-REFERENCE TO RELATED APPLICATIONS

The present application claims priority to U.S. Provisional Application No. 63/395,526, filed on Aug. 5, 2022, titled “POSITIONING PROTOCOL ENHANCEMENTS FOR SIDELINK POSITIONING,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have expanded to allow user equipment (UEs) to connect directly to one another using a technique called sidelink communications. This allows UEs to communicate with one another without relying on a radio access network as an intermediary. By using sidelink communications, UEs can exchange data with high data rates and low latency even when one or both of the UEs are out of network coverage.

### SUMMARY

This disclosure describes techniques for positioning protocol enhancements for sidelink positioning. These techniques can be used to implement a positioning protocol, such as the Long Term Evolution (LTE) Positioning Protocol (LPP), in a way that enables it to be used between UEs over sidelink, including scenarios in which the UEs are out of coverage. In accordance with an aspect of the disclosure, enhancements to the sidelink protocol stack to carry LPP are described. Specifically, new LPP transport mechanisms for sidelink are disclosed that add and/or enhance messages to support LPP transport over, for example, PC5-RRC, PC5-S, and/or Packet Data Convergence Protocol (PDCP). Enhancements to LPP functionality are also disclosed that support capability transfer, assistance data transfer, location information transfer, and other functionality over sidelink.

In general, in an aspect, a method to be performed by a first user equipment (UE) includes receiving a positioning message over a sidelink interface between the first UE and a second UE, generating, by the first UE, a response to the positioning message, and transmitting the response to the second UE over the sidelink interface.

In general, in an aspect, a device, such as a first UE, includes one or more processors and memory storing instructions executable by the one or more processors to receive a positioning message over a sidelink interface between the device and a second device (e.g., a second UE), generate, by the device, a response to the positioning message, and transmit the response to the second device over the sidelink interface.

In general, in an aspect, a system includes one or more processors and memory storing instructions executable by the one or more processors to receive a positioning message over a sidelink interface between a first UE and a second UE, generate, by the first UE, a response to the positioning message, and transmit the response to the second UE over the sidelink interface.

In general, in an aspect, a non-transitory computer-readable medium stores instructions executable by one or more processors to cause the one or more processors to receive a positioning message over a sidelink interface between a first UE and a second UE, generate, by the first UE, a response to the positioning message, and transmit the response to the second UE over the sidelink interface.

In general, in an aspect, one or more processors of a first UE are configured to cause the first UE to perform operations including receiving a positioning message over a sidelink interface between the first UE and a second UE, generating, by the first UE, a response to the positioning message, and transmitting the response to the second UE over the sidelink interface.

In general, in an aspect, one or more processors of a first UE are configured to cause the first UE to perform operations including receiving a positioning message over a sidelink interface between the first UE and a second UE, in which the positioning message includes at least one of a dedicated positioning message received over PC5-RRC, a broadcast positioning message received over PC5-S, or a positioning system information block (posSIB), generating, by the first UE, a response to the positioning message, and transmitting the response to the second UE over the sidelink interface

The foregoing and other aspects can each optionally include one or more of the following features, alone or in combination.

In some examples, the sidelink interface is a PC5 interface. In some examples, receiving the positioning message over the sidelink interface includes receiving the positioning message over PC5-RRC or Packet Data Convergence Protocol (PDCP). In some examples, receiving the positioning message over the sidelink interface includes receiving a broadcast of the positioning message over PC5-S.

In some examples, the positioning message includes a Long-Term Evolution Positioning Protocol (LPP) message. In some examples, the positioning message includes a sidelink-specific LPP message or a sidelink-specific information element. In some examples, the operations include receiving an LPP message over the sidelink interface, the LPP message including an information element comprising the positioning message.

In some examples, the operations include receiving a Shared Control Channel (SCCH) message over the sidelink interface, the SCCH message including the positioning message. In some examples, the operations include receiving a Radio Resource Control (RRC) reconfiguration sidelink message or a RRC reconfiguration complete sidelink message including the positioning message over the sidelink interface.

In some examples, the operations include decoding the positioning message to determine one or more of: sidelink positioning methods supported by the second UE, bandwidth supported by the second UE, or whether the second UE has knowledge of its absolute coordinates.

In some examples, the operations include decoding the positioning message to determine the absolute coordinates of the second UE. In some examples, the operations include decoding the positioning message to determine a sidelink positioning reference signal configuration of the second UE.

In some examples, the positioning message includes a request for positioning measurements, and the operations include performing the positioning measurements based on the request, and generating the response to the positioning message, the response including the positioning measurements.

In some examples, the positioning message includes a request for a location of the first UE, and the operations include determining, by the first UE, the location of the first UE, and generating the response to the positioning message, the response including the location of the first UE.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example positioning architecture of a wireless communication system.

FIG. 2 illustrates an example protocol stack.

FIG. 3 illustrates an example wireless communication system that includes sidelink communications.

FIG. 4 illustrates an example sidelink positioning architecture.

FIGS. 5, 6, and 7 each illustrate examples of an enhanced protocol stack.

FIG. 8 illustrates a flowchart of an example sidelink positioning process.

FIG. 9 illustrates a user equipment (UE), in accordance with some embodiments.

FIG. 10 illustrates an access node, in accordance with some embodiments.

### DETAILED DESCRIPTION

Some wireless communication systems, including as those configured according to the Third Generation Partnership Project (3GPP) wireless communication standards, include functionality to determine the geographical position of a user equipment (UE). Once determined, a UE's position can be used in support of radio resource management functions, as well as location-based services such as navigation, localization, and emergency services, among others.

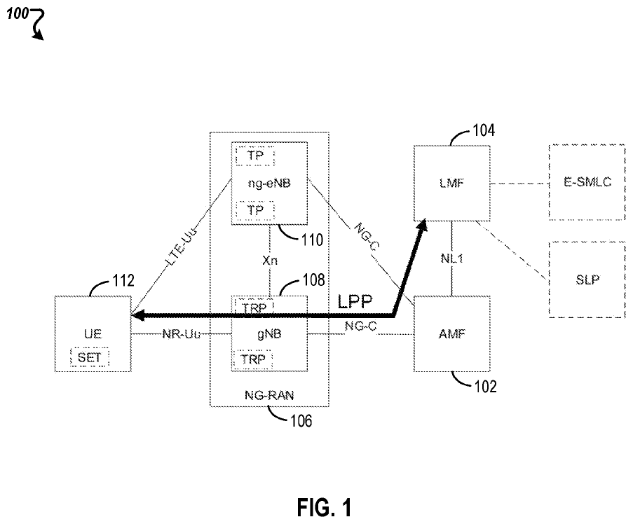

To support positioning of a UE, a wireless communication system can include a positioning architecture. For example, FIG. 1 shows a positioning architecture 100 of a wireless communication system, according to some implementations. In this example, the wireless communication system includes a radio access network (RAN) and a core network (CN), each of which include a plurality of entities that make up the positioning architecture 100. For example, the CN can include an Access and Mobility Management Function (AMF) 102 and a Location Management Function (LMF) 104. The RAN can be a Next Generation (NG) Radio Access Network (NG-RAN) 106 that includes a gNB 108 and/or an eNB 110. The gNB 108 and/or eNB 110 can include one or more transmission/reception points (TRPs). A TRP is a set of geographically co-located antennas (e.g., an antenna array that includes one or more antenna elements) that support transmission and/or reception functionality with UEs in a specific area, such as the UE 112.

In operation, the AMF 102 can receive a request for a location service associated with the UE 112 from another entity (e.g., the UE or a Gateway Mobile Location Center [GMLC]), or the AMF 102 itself can decide to initiate a location service on behalf of the UE 112 (e.g., to locate the UE for an emergency call). The AMF 102 can then send a location services request to the LMF 104. The LMF 104 processes the location services request, which can include determining the position of the UE 112, transferring assistance data to the UE 112 to assist with UE-based and/or UE-assisted positioning, or the like. The LMF 104 can then return the results of the location service (e.g., a position estimate for the UE 112) back to the AMF 102. In the case of a location service requested by an entity other than the AMF 102 (e.g., a GMLC or UE), the AMF 102 can return the location service result to this entity.

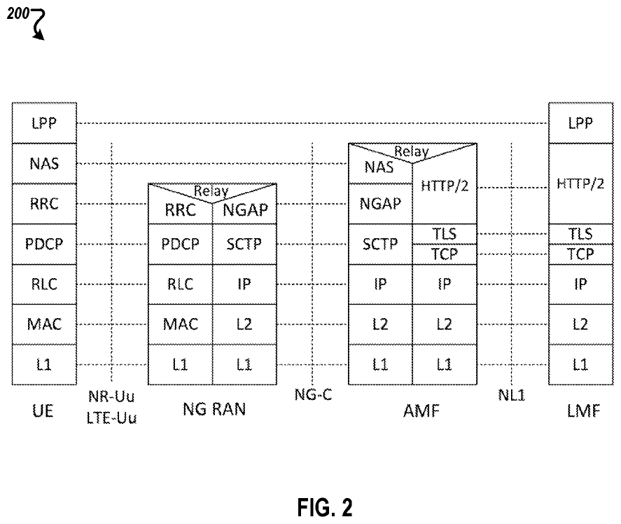

As noted above, the LMF 104 can interact with the UE 112 in order to obtain a location estimate or positioning measurements, or to transfer assistance data to the UE, among other things. To do so, the LMF 104 can utilize a positioning protocol, such as the Long Term Evolution (LTE) Positioning Protocol (LPP). In general, the LPP is a point-to-point protocol used between a positioning server (e.g., the LMF 104 in the control plane, or SLP in the user plane) and a target device (e.g., the UE 112 in the control plane, or the SET in the user plane). LPP can use various protocols as the underlying transport, including (but not limited to) control-plane and user-plane protocols. For example, in the control-plane case, LPP messages (e.g., L.PP protocol data unit [PDUs]) can be transported between the LMF 104 and the UE 112 on top of the non-access stratum (NAS), as shown by the protocol stack 200 in FIG. 2. Other LPP configurations and underlying transports can be used without departing from the scope of the present disclosure.

More recently, wireless communication networks have expanded to allow UEs to communicate directly to one another over sidelink. One of the objectives of Release 18 (Rel-18) of the 3GPP communication standards is to support sidelink positioning, including when the UEs are out-of-coverage (e.g., out of communication range or otherwise unable to communicate with the RAN and/or CN). However, when UEs are out of coverage, there is no connection to the wireless communication network, and therefore no connection to the LMF (or another positioning server). As a result, the positioning functionality provided by the LPP cannot be used.

The present disclosure describes techniques for implementing the LPP in a way that enables it to be used between UEs over sidelink, including scenarios in which the UEs are out of coverage. In accordance with an aspect of the disclosure, sidelink protocol stack enhancements to carry LPP over sidelink are described. Specifically, new LPP transport mechanisms for sidelink are disclosed that add and/or enhance messages to support LPP transport over, for example, PC5-RRC, PC5-S, and/or Packet Data Convergence Protocol (PDCP) interfaces. Enhancements to LPP functionality are also disclosed that support capability transfer, assistance data transfer, location information transfer, and other functionality over sidelink. Although aspects of the present disclosure are described in the context of LPP, these aspects can be applied to other positioning protocols (or used to define a new sidelink positioning protocol) without departing from the scope of the disclosure.

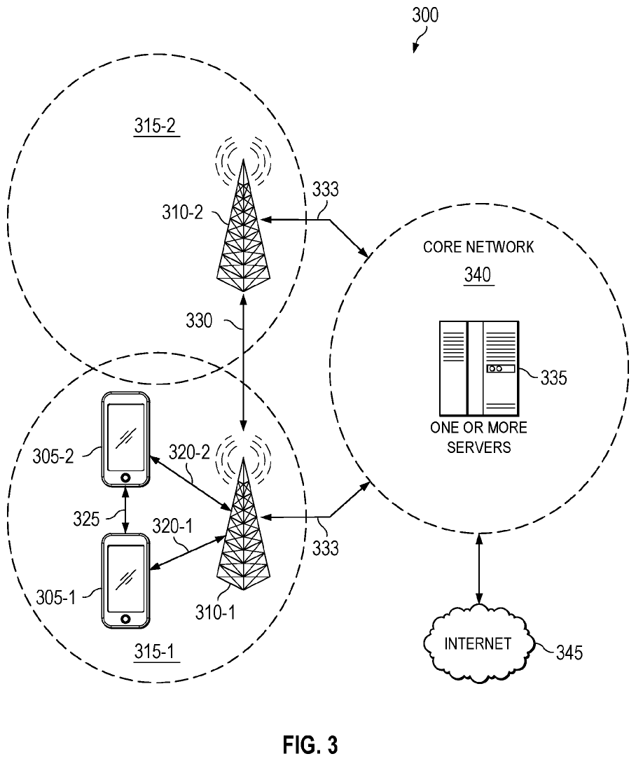

Referring to FIG. 3, an example wireless communication system 300 that includes sidelink communications is shown. It is noted that the system of FIG. 3 is merely one example of a possible system, and that features of this disclosure may be implemented in other wireless communication systems.

The following description is provided for an example communication system 300 that operates in conjunction with fifth generation (5G) networks as provided by 3GPP technical specifications (TS). However, the example implementations are not limited in this regard and the described implementations may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G)) systems. While aspects may be described herein using terminology commonly associated with 5G NR, aspects of the present disclosure can be applied to other systems, such as 3G, 4G, and/or systems subsequent to 5G (e.g., 6G).

As shown in FIG. 3, the communication system 300 includes UEs 305 (UE 305-1 and UE 305-2 are collectively referred to as “UE 305” or “UEs 305”), base stations 310 (base station 310-1 and base station 310-2 are collectively referred to as “base station 310” or “base stations 310”), cells 315 (cell 315-1 and cell 315-2 are collectively referred to as “cell 315” or “cells 315”), and one or more servers 335 in a core network (CN) 340 that is connected to the Internet 345.

In some examples, the UEs 305 may be physical hardware devices running one or more applications and capable of communicating with one or more base stations 310 and/or other UEs. Radio links 320 (radio link 320-1 and radio link 320-2 are collectively referred to as “radio link 320” or “radio links 320”) can allow the UEs 305 to transmit and receive data from the base station 310 that provides the link 320. In some examples, the radio links 320 can be Uu interfaces (e.g., NR-Uu and/or LTE-Uu, among others) between the UEs 305 and the base stations 310. A sidelink interface 325 can allow the UEs 305 to transmit and receive data from one another directly (e.g., without an intermediary infrastructure device such as a base station 310). In some examples, the sidelink 325 can be a PC5 interface between UEs 305 (and/or other UEs, such as roadside unit [RSU] UEs). The PC5 and Uu interfaces are used only as examples, and PC5 as used herein may represent various other possible wireless communications technologies that allow for direct sidelink communications between user devices, while Uu in turn may represent cellular communications conducted between user devices and infrastructure devices, such as base stations. In some examples, the base stations 310 are capable of communicating with one another over a backhaul connection 330 (e.g., an X2 interface), and may communicate with the one or more servers 335 within a core network (CN) 340 over other connections 333 (e.g., NG-C or NG-U).

To transmit/receive data to/from one or more base stations 310 or other UEs, the UEs 305 may include a transmitter/receiver (or, alternatively, a transceiver), memory, one or more processors, and/or other like components that enable the UEs 305 to operate in accordance with one or more wireless communications protocols and/or one or more cellular communications protocols. The UEs 305 may have multiple antenna elements that enable the UEs 305 to maintain multiple links 320 and/or sidelinks 325 to transmit/receive data to/from multiple base stations 310 and/or multiple UEs 305. For example, as shown in FIG. 3, UE 305-1 may connect with base station 310-1 via link 320-1 and simultaneously connect with UE 305-2 via sidelink 325. In some examples, one or both of the UEs 305 may be out of coverage of the base stations 310 (e.g., outside the cells 315 and unable to communicate with the base stations 310), but may still communicate with one another via sidelink 325.

The sidelink 325 between the UEs 305 may include one or more channels for transmitting information between UE 305-1 and UE 305-2, and/or between UEs 305 and UE-type RSUs (not shown in FIG. 3). For example, the sidelink 325 can be a PC5 interface that includes (but is not limited to) a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the sidelink 325 can operate on an unlicensed spectrum (e.g., in the unlicensed 5 Gigahertz (GHz) and 6 GHz bands) or a (licensed) shared spectrum. The UEs 305 can use the PC5 interface for a radio resource control (RRC) signaling (e.g., PC5-RRC) exchange between the UEs, among other protocols (e.g., PC5-S and/or PDCP).

In some examples, the UEs 305 are configured to use a resource pool for sidelink communications. A sidelink resource pool may be divided into multiple time slots, frequency channels, and frequency sub-channels. In some examples, the UEs 305 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window, which may be determined using packet delay budget information.

In some examples, the communication system 300 is configured to perform sidelink positioning for one or both of the UE 305 served by the communication system 300. For example, the CN 340 of the communication system 300 can include a positioning server, such as an LMF (not shown), configured to interact with the UEs 305 in order to obtain a location estimate or positioning measurements, or to transfer assistance data to the UE 305, among other things. However, as noted above, the UEs may be unable to connect to the communication system 300 in some scenarios (e.g., due to being out of the coverage area of the base stations 310), and therefore unable to communicate with the LMF (or another positioning server). As a result, the positioning functionality provided by the LPP that terminates at the LMF cannot be used.

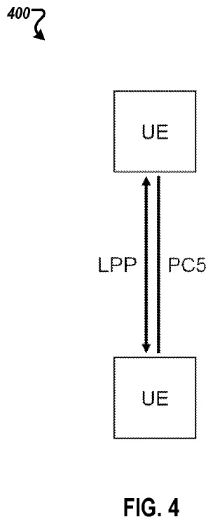

In accordance with an aspect of the present disclosure, the sidelink protocol stack can be enhanced to support the LPP (or another positioning protocol) over sidelink. These enhancements can enable LPP messages to be transported over the sidelink interface (e.g., PC5 interface) between UEs, as shown in the sidelink positioning architecture 400 in FIG. 4. By enhancing the sidelink protocol in this way, the techniques described here enable UE positioning over sidelink, including when the UEs are out of coverage.

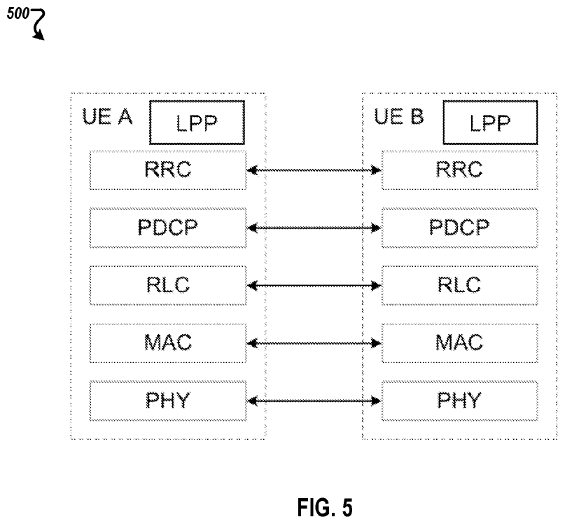

In some examples, a new LPP transport mechanism for sidelink can be defined on top of PC5-RRC, as shown by the enhanced protocol stack 500 in FIG. 5. For example, a new PC5-RRC procedure/message, referred to herein as “Information Transfer,” can be defined that carries LPP messages over sidelink. In some examples, the Information Transfer message can be incorporated into the SCCH-Message class and can carry an LPP PDU in an OCTET STRING container, as shown in the following table.

| | |
|---|---|
| SCCH-MessageType ::= | CHOICE { |
| c1 | CHOICE { |
| measurementReportSidelink | MeasurementReportSidelink, |
| rrcReconfigurationSidelink | RRCReconfigurationSidelink, |
| rrcReconfigurationCompleteSidelink | RRCReconfigurationCompleteSidelink, |
| rrcReconfigurationFailureSidelink | RRCReconfigurationFailureSidelink, |
| ueCapabilityEnquirySidelink | UECapabilityEnquirySidelink, |
| ueCapabilityInformationSidelink | UECapabilityInformationSidelink, |
| slInformationTransfer | SLInformationTransfer, |

```
    spare1 NULL
  },
```

| | |
|---|---|
| messageClassExtension | SEQUENCE { } |

}

| | |
|---|---|
| SLInformationTransfer ::= | SEQUENCE { |
| lpp-Message | LPP-Message OPTIONAL, |
| nonCriticalExtension | SEQUENCE { } OPTIONAL |

}

| | |
|---|---|
| LPP-Message ::= | OCTET STRING |

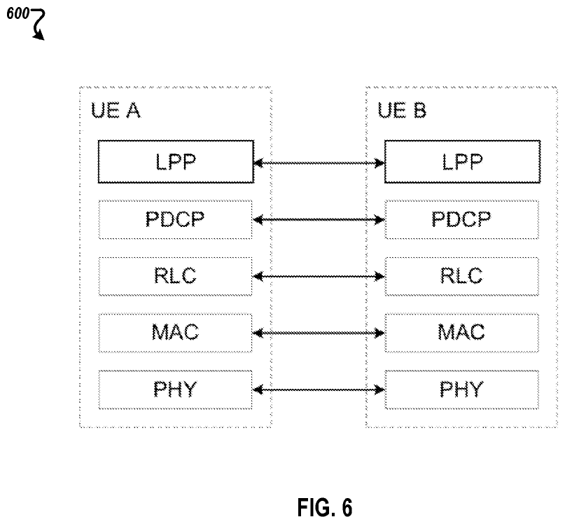

In some examples, transport of LPP messages over sidelink can be implemented by means other than definition of a new message. For example, the RRCReconfigurationSidelink and/or the RRCReconfigurationCompleteSidelink messages (or another message in the SCCH-Message class) can be extended with a new container information element (IE) to carry an LPP message over sidelink. As another example, a new sidelink signal radio bearer (SRB) and/or logical channel identifier (LCID) can be defined to carry LPP messages on top of PDCP (e.g., instead of or in addition to RRC). For example, a new LCID (e.g., in the 20-61 range of Table 6.2.4-1 in 3GPP TS 36.321 version 17.1.0 and/or 3GPP TS 38.321 version 17.1.0) can be reserved for LPP transport over sidelink. Such a modification is shown by the enhanced protocol stack 600 in FIG. 6.

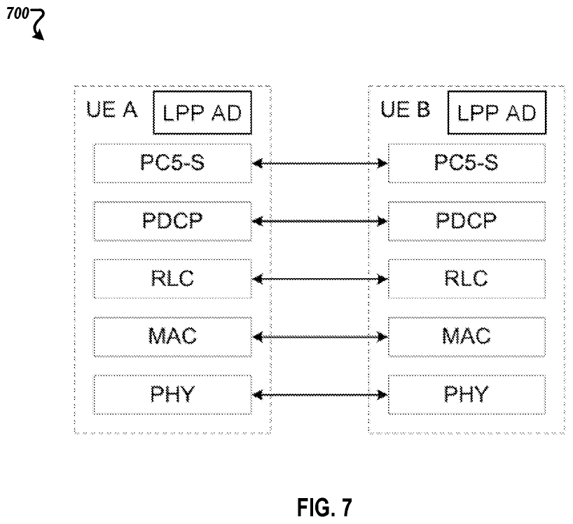

In some scenarios, positioning assistance information is delivered through positioning system information blocks (posSIBs) in addition to dedicated LPP signaling. However, some sidelink implementations may not support SIB delivery. In accordance with an aspect of the present disclosure, positioning assistance data can be delivered using dedicated LPP signaling. In some examples, the sidelink protocol stack can be enhanced to support SIB delivery by, for example, defining and/or extending messages over PC5-RRC, PDCP in order to carry posSIB in a manner similar to Uu. In some examples, an upper layer protocol (e.g., PC5-S) can be extended to support broadcast of positioning assistance data, as shown by the enhanced protocol stack 700 in FIG. 7.

In accordance with an aspect of the present disclosure, LPP functionality can be enhanced to support UE positioning over sidelink. To do so, new sidelink-specific functionality can be added to the LPP functionality, and/or existing LPP functionality can be extended to support sidelink operation. Enhancements to LPP functionality can include (but are not limited to) enhancements to capability transfer, assistance data transfer, and/or location information transfer.

In some examples, sidelink-specific functionality is added to some or all of the LPP IEs. For example, sidelink-specific functionality can be added through extensions to the data carried by some or all of RequestCapabilities, ProvideCapabilities, RequestAssistanceData, ProvideAssistanceData, RequestLocationInformation, and ProvideLocationInformation included in LPP-MessageBody in the 3GPP standards. Alternatively, or in addition, a new sidelink-specific LPP message is defined (e.g., SL-LPP-Message, which can be similar to LPP-Message in the 3GPP standards). This may be beneficial if sidelink requires transport layer enhancements that are not supported by LPP. In some examples, a new sidelink-specific LPP high-level IF is defined (e.g., SL-LPP-MessageBody, which can be similar to LPP-MessageBody defined in the 3GPP standards). This may be beneficial if there is desire to keep sidelink-related positioning functionality separate from legacy positioning. In some examples, LPP-MessageBody itself can remain unchanged.

In some examples, to support LPP capability transfer over sidelink, a NR-SL-RequestCapabilities IE is added to RequestCapabilities, and/or a NR-SL-ProvideCapabilities IE is added to ProvideCapabilities. In some examples, new functions supporting sidelink capability transfer can be added, including (but not limited to) one or more of: supported sidelink positioning methods (e.g., sidelink time difference of arrival [TDOA], sidelink round trip time [RTT], sidelink angle of arrival [AoA], sidelink angle of departure [AoD]; supported bandwidth; and/or supported bands and frequency ranges. One or more of these new functions can be implemented by extending or adding messages within the sidelink protocol stack, as described herein.

In general, absolute coordinates of a UE can be measured or otherwise estimated using LPP. However, measuring of absolute coordinates may not be possible in sidelink due to the lack of a fixed reference point when the UEs are mobile. However, if one of the UEs is stationary, such as in the case of UE-type RSUs, the stationary UE may have known absolute coordinates, which a UE can use to measure its own absolute coordinates over sidelink. Accordingly, in some examples, a new sidelink capability transfer function can be added to indicate knowledge of absolute coordinates (e.g., in the case of UE-type RSUs).

In some examples, to support LPP assistance data transfer over sidelink, a NR-SL-RequestAssistanceData IE is added to RequestAssistanceData, and/or a NR-SL-ProvideAssistanceData IE is added to ProvideAssistanceData. In some examples, new functions supporting sidelink assistance data transfer can be added, including (but not limited to) known absolute coordinates and/or sidelink positioning reference signal (PRS) configuration. As discussed herein, sidelink positioning assistance data can be transferred over sidelink using dedicated LPP signaling, posSIB in sidelink SIB, and/or broadcast on top of PC5-S, among others. One or more of these new functions can be implemented by extending or adding messages within the sidelink protocol stack, as described herein.

In some examples, to support LPP location information transfer over sidelink, a NR-SL-XYZ-RequestLocationInformation IE is added to RequestLocationInformation, and/or a NR-SL-XYZ-ProvideLocationInformation IE is added to ProvideLocationInformation, where “XYZ” is a positioning method supported over sidelink (e.g., sidelink TDOA, sidelink RTT, sidelink AoA, sidelink AoD).

In some examples, for each positioning method, two IEs can be included: measurement information elements (e.g., NR-SL-TDOA-SignalMeasurementInformation) to carry the corresponding measurements, and location information elements (e.g., NR-SL-TDOA-LocationInformation) to carry the location estimated with the corresponding positioning method. In the former case, a first UE (e.g., UE1) requests a second UE (e.g., UE2) to perform, e.g., sidelink TDOA measurements, and UE2 reports the measurements to UE1 to enable UE1 to calculate the location of UE2. In the latter case, UE1 calculates its location and can provide its location estimate to UE2. Even though LPP is peer-to-peer, normally a UE would need to perform PRS measurements with at least three other UEs to calculate its absolute location. When only ranging is needed (e.g., with SL RxTx time difference measurement or other RTT measurement), the procedure may be performed just between two UEs.

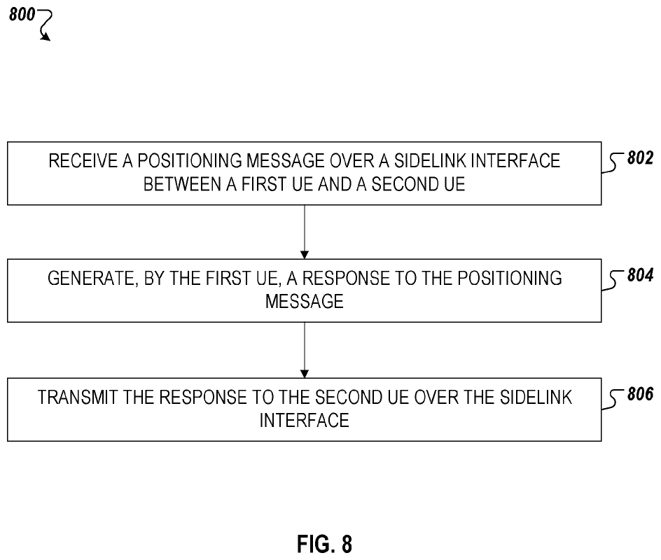

FIG. 8 illustrates a flowchart of an example process 800, according to some implementations. For clarity of presentation, the description that follows generally describes method 800 in the context of the other figures in this description. For example, process 800 can be performed by a first UE in a wireless communication system (e.g., UE 305-1 of FIG. 3). It will be understood that process 800 can be performed, for example, by any suitable system, environment, software, hardware, or a combination of systems, environments, software, and hardware, as appropriate. In some implementations, various steps of process 800 can be run in parallel, in combination, in loops, or in any order.

Operations of the process 800 include receiving a positioning message over a sidelink interface between a first UE and a second UE (802). For example, the first UE can be the UE 305-1 that receives a positioning message from the second UE 305-2 over the sidelink interface 325, which can be a PC5 interface. In some examples, the positioning message is a LPP positioning message received over the sidelink interface. One or both of the UEs can be out of coverage of the network (e.g., outside of the cells 315 or otherwise unable to communicate with the base stations 310).

In some examples, the positioning message is received over PC5-RRC. For example, the positioning message can be included in a SCCH-Message received on the sidelink interface over PC5-RRC. As another example, a RRCReconfigurationSidelink or a RRCReconfigurationCompleteSidelink message including the positioning message can be received on the sidelink interface over PC5-RRC. In some examples, the positioning message can be received by other transport protocols, such as PDCP or PC5-S. In some examples, the positioning message can be received using any combination of the above.

In some examples, the positioning message comprises a sidelink-specific LPP message (e.g., SL-LPP-Message, which can be similar to LPP-Message), or a sidelink specific IF (e.g., SL-LPP-MessageBody, which can be similar to LPP-MessageBody). In some examples, an LPP-MessageBody message/IE can be received over the sidelink interface that includes an IE containing the positioning message. For example, the received LPP-MessageBody can include a sidelink-specific IE carrying the positioning message in one of RequestCapabilities, ProvideCapabilities, RequestAssistanceData, ProvideAssistanceData, RequestLocationInformation, or ProvideLocationInformation. In some examples, the positioning message comprises any combination of the above.

After receiving the positioning message, the first UE can generate a response (804). In some examples, the first UE decodes the positioning message and responds accordingly. For example, the first UE can decode the positioning message to determine capability information for the second UE, such as one or more sidelink positioning methods supported by the second UE, a bandwidth supported by the second UE, and/or whether the second UE has knowledge of its absolute coordinates. In some examples, the first UE can decode the positioning message to obtain assistance data from the second UE, such as the absolute coordinates of the second UE and/or a sidelink positioning reference signal configuration of the second UE.

The first UE then transmits the generated response to the second UE over the sidelink interface (806). For example, the positioning message can include a request for positioning measurements (which can include an indication of a particular sidelink positioning method). In response, the first UE can perform the positioning measurements (e.g., based on the positioning method indicated in the request), and generate the response including the positioning measurements. The second UE can then use the positioning measurements contained in the response to calculate the first UE's position. As another example, the positioning message can include a request for the first UE's location, and the first UE can calculate its location and include it in the response transmitted to the second UE over the sidelink interface.

Although the process 800 was described in the context of the first UE receiving the positioning message and generating a response, it will be apparent from the present disclosure that the described processes can be performed from the perspective of the first UE transmitting the positioning message and receiving a response.

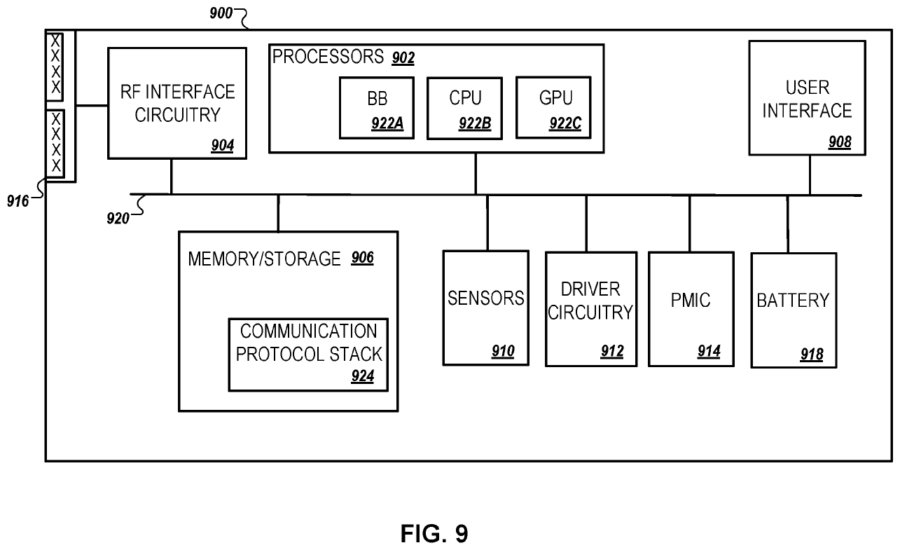

FIG. 9 illustrates a UE 900, in accordance with some embodiments. The UE 900 may be similar to and substantially interchangeable with UE 305 of FIG. 3.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, one or more antennas 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some embodiments, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 904. The baseband processor circuitry 922A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some embodiments, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the one or more antennas 916.

In various embodiments, the RF interface circuitry 904 may be configured to transmit/receive signals in a manner compatible with NR access technologies.

The one or more antennas 916 may include antenna elements to convert electrical signals into radio waves to travel through the air and to convert received radio waves into electrical signals. The antenna elements may be arranged into one or more antenna panels. The antenna 916 may have antenna panels that are omnidirectional, directional, or a combination thereof to enable beamforming and multiple input, multiple output communications. The one or more antennas 916 may include microstrip antennas, printed antennas fabricated on the surface of one or more printed circuit boards, patch antennas, phased array antennas, etc. The one or more antennas 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some embodiments, the PMIC 914 may control, or otherwise be part of, various power saving mechanisms of the UE 900 including DRX as discussed herein. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

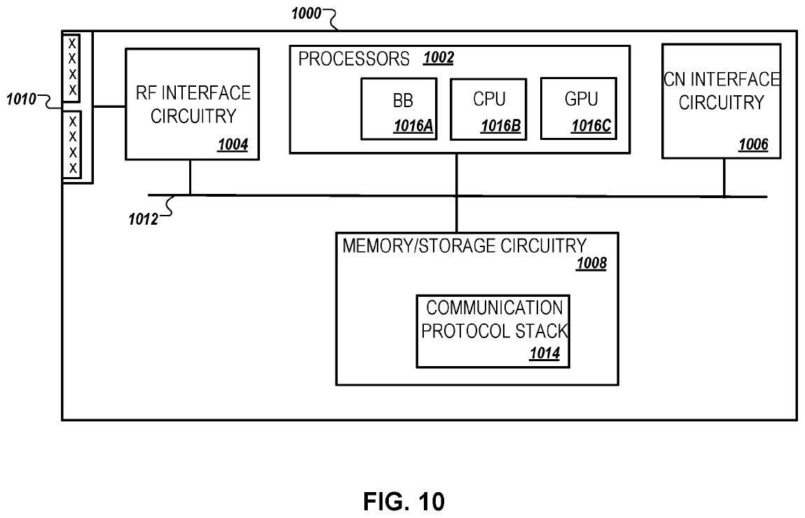

FIG. 10 illustrates an access node 1000 (e.g., a base station or gNB), in accordance with some embodiments. The access node 1000 may be similar to and substantially interchangeable with base station 310 of FIG. 3. The access node 1000 may include processors 1002, RF interface circuitry 1004, core network (CN) interface circuitry 1006, memory/storage circuitry 1008, and one or more antennas 1010.

The components of the access node 1000 may be coupled with various other components over one or more interconnects 1012. The processors 1002, RF interface circuitry 1004, memory/storage circuitry 1008 (including communication protocol stack 1014), the one or more antennas 1010, and interconnects 1012 may be similar to like-named elements shown and described with respect to FIG. 8. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various embodiments, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1000 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes one or more processors of a first user equipment (UE), the one or more processors configured to cause the first UE to perform operations including: receiving a positioning message over a sidelink interface between the first UE and a second UE; generating, by the first UE, a response to the positioning message; and transmitting the response to the second UE over the sidelink interface.

Example 2 is the one or more processors of Example 1, wherein the sidelink interface includes a PC5 interface.

Example 3 is the one or more processors of Examples 1 or 2, wherein the positioning message includes a Long-Term Evolution Positioning Protocol (LPP) message.

Example 4 is the one or more processors of any of Examples 1 to 3, wherein receiving the positioning message over the sidelink interface includes receiving the positioning message over PC5-RRC.

Example 5 is the one or more processors of any of Examples 1 to 4, the operations further including receiving a Shared Control Channel (SCCH) message over the sidelink interface, the SCCH message including the positioning message.

Example 6 is the one or more processors of any of Examples 1 to 5, the operations further including receiving a Radio Resource Control (RRC) reconfiguration sidelink message or a RRC reconfiguration complete sidelink message including the positioning message over the sidelink interface.

Example 7 is the one or more processors of any of Examples 1 to 6, wherein receiving the positioning message over the sidelink interface includes receiving the positioning message over Packet Data Convergence Protocol (PDCP).

Example 8 is the one or more processors of any of Examples 1 to 7, wherein receiving the positioning message over the sidelink interface includes receiving a broadcast of the positioning message over PC5-S.

Example 9 is the one or more processors of any of Examples 1 to 8, wherein the positioning message includes a sidelink-specific LPP message or a sidelink-specific information element.

Example 10 is the one or more processors of any of Examples 1 to 9, the operations further including receiving a Long-Term Evolution Positioning Protocol (LPP) message over the sidelink interface, the LPP message including an information element comprising the positioning message.

Example 11 is the one or more processors of any of Examples 1 to 10, the operations further including decoding the positioning message to determine one or more sidelink positioning methods supported by the second UE.

Example 12 is the one or more processors of any of Examples 1 to 11, the operations further including decoding the positioning message to determine a bandwidth supported by the second UE.

Example 13 is the one or more processors of any of Examples 1 to 12, the operations further including decoding the positioning message to determine whether the second UE has knowledge of its absolute coordinates.

Example 14 is the one or more processors of any of Examples 1 to 13, the operations further including decoding the positioning message to determine the absolute coordinates of the second UE.

Example 15 is the one or more processors of any of Examples 1 to 14, the operations further including decoding the positioning message to determine a sidelink positioning reference signal configuration of the second UE.

Example 16 is the one or more processors of any of Examples 1 to 15, wherein the positioning message includes a request for positioning measurements, the operations further including: performing the positioning measurements based on the request; and generating the response to the positioning message, the response including the positioning measurements.

Example 17 is the one or more processors of any of Examples 1 to 16, wherein the positioning message includes a request for a location of the first UE, the operations further including: determining, by the first UE, the location of the first UE; and generating the response to the positioning message, the response including the location of the first UE.

Example 18 is the one or more processors of any of Examples 1 to 17, wherein at least one of the first UE and the second UE is out of coverage of a wireless communication network.

Example 19 includes one or more processors of a first user equipment (UE), the one or more processors configured to cause the first UE to perform operations including: receiving a positioning message over a sidelink interface between the first UE and a second UE, wherein the positioning message includes at least one of a dedicated positioning message received over PC5-RRC, a broadcast positioning message received over PC5-S, or a positioning system information block (posSIB); generating, by the first UE, a response to the positioning message; and transmitting the response to the second UE over the sidelink interface.

Example 20 includes a non-transitory computer storage medium encoded with instructions executable by one or more processors to cause the one or more processors to perform the operations of any of Examples 1 to 19.

Example 21 includes a device including or more processors and memory storing instructions executable by the one or more processors to cause the one or more processors to perform the operations of any of Examples 1 to 19.

Example 22 includes a method for performing the operations of any of Examples 1 to 19.

Example 23 includes a user equipment (UE) including one or more processors and memory storing instructions executable by the one or more processors to cause the one or more processors to perform the operations of any of Examples 1 to 19.

Example 24 includes a system including one or more processors and memory storing instructions executable by the one or more processors to cause the one or more processors to perform the operations of any of Examples 1 to 19.

Example 25 may include an apparatus including logic, modules, or circuitry to perform one or more elements of the operations described in or related to any of Examples 1 to 19, or any other operations or process described herein.

Example 26 may include a method, technique, or process as described in or related to the operations of any of Examples 1 to 19, or portions or parts thereof.

Example 27 may include an apparatus, e.g., a user equipment, including: one or more processors and one or more computer-readable media including instructions that, when executed by the one or more processors, cause the one or more processors to perform the method, techniques, or process as described in or related to the operations of any of Examples 1 to 19, or portions thereof.

Example 28 may include a signal as described in or related to any of Examples 1 to 19, or portions or parts thereof.

Example 29 may include a datagram, information element (IE), packet, frame, segment, PDU, or message as described in or related to any of Examples 1 to 19, or portions or parts thereof, or otherwise described in the present disclosure.

Example 30 may include a signal encoded with data as described in or related to any of Examples 1 to 19, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to the operations of any of Examples 1 to 19, or portions thereof.

Example 32 may include a computer program including instructions, wherein execution of the program by a processing element is to cause the processing element to carry out the method, techniques, or process as described in or related to the operations of any of Examples 1 to 19, or portions thereof. The operations or actions performed by the instructions executed by the processing element can include the operations of any one of Examples 1 to 19.

Example 33 may include a signal in a wireless network as shown and described herein.

Example 34 may include a method of communicating in a wireless network as shown and described herein.

Example 35 may include a system for providing wireless communication as shown and described herein. The operations or actions performed by the system can include the operations of any one of Examples 1 to 19.

Example 36 may include a device for providing wireless communication as shown and described herein. The operations or actions performed by the device can include the operations of any one of Examples 1 to 19.

The previously-described operations of Examples 1 to 19 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-22. (canceled)

23. One or more processors configured to, when executing instructions stored in memory, perform operations comprising:
instructing radio frequency (RF) circuitry to receive a positioning message over a sidelink interface between a first user equipment (UE) and a second UE;
generating a response to the positioning message; and
instructing RF circuitry to transmit the response to the second UE over the sidelink interface.

24. The one or more processors of claim 23, wherein the sidelink interface comprises a PC5 interface.

25. The one or more processors of claim 23, wherein the positioning message comprises a Long-Term Evolution Positioning Protocol (LPP) message, a sidelink-specific LPP message, or a message comprising a sidelink-specific information element.

26. The one or more processors of claim 23, wherein instructing RF circuitry to receive the positioning message over the sidelink interface comprises instructing RF circuitry to receive the positioning message over PC5-RRC, or instructing RF circuitry to receive a broadcast of the positioning message over PC5-S.

27. The one or more processors of claim 23, the operations further comprising:
instructing RF circuitry to receive a Shared Control Channel (SCCH) message over the sidelink interface, the SCCH message comprising the positioning message, or
instructing RF circuitry to receive a Radio Resource Control (RRC) reconfiguration sidelink message over the sidelink interface, the RRC reconfiguration sidelink message comprising the positioning message.

28. The one or more processors of claim 23, the operations further comprising decoding the positioning message to determine one or more sidelink positioning capabilities of the second UE.

29. The one or more processors of claim 28, wherein the one or more sidelink positioning capabilities comprise one or more sidelink positioning methods supported by the second UE, the one or more sidelink positioning methods comprising at least one of sidelink round trip time, sidelink time difference of arrival, or sidelink angle of arrival.

30. The one or more processors of claim 28, wherein the one or more sidelink positioning capabilities comprise a bandwidth supported by the second UE for sidelink positioning.

31. The one or more processors of claim 23, wherein the positioning message comprises a request for one or more sidelink positioning capabilities of the first UE, and wherein the response to the positioning message comprises an indication of the one or more sidelink positioning capabilities of the first UE.

32. The one or more processors of claim 31, wherein the one or more sidelink positioning capabilities comprise one or more sidelink positioning methods supported by the first UE, the one or more sidelink positioning methods comprising at least one of sidelink round trip time, sidelink time difference of arrival, or sidelink angle of arrival.

33. The one or more processors of claim 31, wherein the one or more sidelink positioning capabilities comprise a bandwidth supported by the first UE for sidelink positioning.

34. The one or more processors of claim 23, the operations further comprising decoding the positioning message to determine sidelink assistance data for the second UE, wherein the sidelink assistance data comprises coordinates of the second UE.

35. The one or more processors of claim 23, wherein the positioning message comprises a request for sidelink assistance data for the first UE, and wherein the response to the positioning message comprises the sidelink assistance data, the sidelink assistance data comprising coordinates of the first UE.

36. The one or more processors of claim 23, the operations further comprising decoding the positioning message to determine whether the second UE has knowledge of its absolute coordinates.

37. The one or more processors of claim 23, the operations further comprising decoding the positioning message to determine a sidelink positioning reference signal configuration of the second UE.

38. The one or more processors of claim 23, the operations further comprising decoding the positioning message to obtain sidelink location information for the second UE, the sidelink location information comprising at least one of a sidelink round trip time measurement, a sidelink time difference of arrival measurement, or a sidelink angle of arrival measurement.

39. The one or more processors of claim 23, wherein the positioning message comprises a request for positioning measurements, the operations further comprising:
performing the positioning measurements based on the request; and
generating the response to the positioning message, the response including the positioning measurements.

40. The one or more processors of claim 23, wherein the positioning message comprises a request for a location of the first UE, the operations further comprising:
determining, by the first UE, the location of the first UE; and
generating the response to the positioning message, the response including the location of the first UE.

41. One or more processors configured to, when executing instructions stored in memory, perform operations comprising:
instructing radio frequency (RF) circuitry to receive a positioning message over a sidelink interface between a first user equipment (UE) and a second UE, wherein the positioning message comprises at least one of a dedicated positioning message received over PC5-RRC, a broadcast positioning message received over PC5-S, or a positioning system information block (posSIB);
generating a response to the positioning message; and
instructing RF circuitry to transmit the response to the second UE over the sidelink interface.

42. A method, comprising:
instructing radio frequency (RF) circuitry to transmit a positioning message over a sidelink interface between a first UE and a second UE;
generating a response to the positioning message; and
instructing RF circuitry to transmit the response to the second UE over the sidelink interface.
